(19) United States
(12) Patent Application Publication
(10) Pub. No.: US 2023/0159012 A1
(43) Pub. Date: May 25, 2023

(54) DEVICE AND METHOD FOR ESTIMATING PARAMETERS FOR A VEHICLE BRAKE SYSTEM EQUIPPED WITH A MOTORIZED PISTON-CYLINDER DEVICE

(71) Applicant: Robert Bosch GmbH, Stuttgart (DE)

(72) Inventors: Manfred Gerdes, Vaihingen/Enz (DE); Reid Collins, Forchtenberg (DE); Daniel Frank, Kleinsachsenheim (DE)

(21) Appl. No.: 17/997,149

(22) PCT Filed: Jun. 15, 2021
(86) PCT No.: PCT/EP2021/066016

§ 371 Date: Oct. 26, 2022

(30) Foreign Application Priority Data
Sep. 2, 2020 (DE) 10 2020 211 056.5

(51) Int. Cl. B60T 8/171; B60T 17/22; B60T 13/74; B60T 8/172

(52) U.S. Cl. CPC B60T 8/171; B60T 17/22; B60T 13/745; B60T 8/172; B60T 2270/88

(57) ABSTRACT

Parameter estimation for a vehicle brake system equipped with a motorized piston-cylinder device. The estimation includes controlling an electric motor of the motorized piston-cylinder device so that at least one piston, displaceable by the operated electric motor, of the motorized piston-cylinder device is displaced from its initial position; ascertaining/estimating a brake fluid volume displaced by the at least one displaceable piston of the motorized piston-cylinder device between the motorized piston-cylinder device and at least a part of the brake system adjoining the motorized piston-cylinder device; ascertaining/estimating a change in pressure occurring due to the displaced brake fluid volume at least in the part of the brake system adjoining the motorized piston-cylinder device; and determining an elasticity of the brake system and/or a rigidity of the brake system at least taking into account the ascertained or estimated displaced brake fluid volume and the ascertained or estimated change in pressure.

### FIELD

The present invention relates to a device for parameter estimation for a vehicle brake system equipped with a motorized piston-cylinder device, and to a vehicle brake system for a vehicle. The present invention also relates to a method for parameter estimation for a vehicle brake system equipped with a motorized piston-cylinder device. In addition, the present invention relates to a method for operating a vehicle brake system equipped with a motorized piston-cylinder device.

### BACKGROUND INFORMATION

German Patent Δpplication No. DE 10 2017 212 360 A1 describes equipping a brake system with a motorized piston-cylinder device, which can also be referred to as a motorized plunger device, and with a device or control device for controlling an electric motor of the motorized piston-cylinder device.

### SUMMARY

The present invention provides, among other things, a device for parameter estimation for a vehicle brake system equipped with a motorized piston-cylinder device, a vehicle brake system, a method for parameter estimation for a vehicle brake system equipped with a motorized piston-cylinder device, and a method for operating a vehicle brake system equipped with a motorized piston-cylinder device.

The present invention provides advantageous possibilities for defining/determining at least one elasticity or rigidity as necessary parameters of an inverse system model for a vehicle brake system equipped with a motorized piston-cylinder device. In particular, the present invention provides “robust” possibilities for determining the elasticity and/or the rigidity of the respective brake system, in which a quantity impairing the elasticity and/or rigidity can also be taken into account. Here, even under extreme boundary conditions, a reliable defining of the elasticity and/or of the rigidity of the respective brake system is ensured by the present invention. In particular, the elasticity and/or the rigidity of the respective brake system can be adapted to production-related deviation of the respective brake system from its standard brake system type, changes due to aging in the respective brake system, and/or changing environmental influences acting on the respective brake system. In all the cases listed here, the elasticity and/or rigidity of the respective brake system can be reliably determined. The present invention thus also supports a low-cost mass production of brake systems each equipped with a motorized piston-cylinder device, because even when there is a deviation in one of the brake systems from its typical series product, its elasticity and/or rigidity can still be reliably determined using the present invention.

An advantageous specific embodiment of the device of the present invention has a first low-pass filter device and/or a second low-pass filter device, the computing device being designed and/or programmed to determine the elasticity of the brake system and/or the rigidity of the brake system at least taking into account the displaced brake fluid volume, unfiltered or filtered by the first low-pass filter device, and to determine the change in pressure, unfiltered or filtered by the second low-pass filter device. Through a low-pass filtering carried out by the first low-pass filter device and/or by the second low-pass filter device, a signal noise occurring in the respectively filtered signal can be limited/reduced.

Preferably, according to an example embodiment of the present invention, the computing device is in addition designed and/or programmed to estimate a displacement path of the at least one piston, displaced by the controlled electric motor, of the motorized piston-cylinder device from its respective initial position, or to read it out from a displacement path sensor signal provided to the computing device, the computing device being designed and/or programmed to estimate the brake fluid volume displaced by the at least one movable piston between the motorized piston-cylinder device and at least the part of the brake system adjoining the motorized piston-cylinder device on the basis of the estimated or read-out displacement path of the at least one displaced piston. Because in most cases a motorized piston-cylinder device is standardly equipped with at least one displacement path sensor, such as an angle of rotation sensor of its electric motor, a reliable estimated value can easily be determined for the displaced brake fluid volume using the specific embodiment described here of the device, so that further sensor equipment for measuring the displaced brake fluid volume is no longer required.

In a further advantageous specific embodiment of the device of the present invention, the computing device is in addition designed and/or programmed to estimate a storage volume temporarily stored in at least one storage chamber of the brake system, or to read the storage volume out from a storage volume sensor signal provided to the computing device, the computing device also being designed and/or programmed to determine the elasticity of the brake system and/or the rigidity of the brake system at least taking into account the estimated or read-out displaced brake fluid volume, the estimated or read-out change in pressure, and the storage volume temporarily stored in the at least one storage chamber. The specific embodiment of the device described here thus enables a more accurate and more reliable determination of the elasticity and/or rigidity of the respective brake system.

Likewise, according to an example embodiment of the present invention, the motor control device can in addition be designed and/or programmed to control an electric motor of a motorized brake pressure buildup device of the brake system in such a way that a differential volume can be displaced by the motorized brake pressure buildup device into or out of at least the part of the brake system adjoining the motorized piston-cylinder device, the computing device in addition being designed and/or programmed to estimate the differential volume or to read the differential volume out from at least one additional volume sensor signal provided to the computing device, and to determine the elasticity of the brake system and/or the rigidity of the brake system at least taking into account the estimated or read-out displaced brake fluid volume, the estimated or read-out change in pressure, and the differential volume displaced into or out of at least the part of the brake system adjoining the motorized piston-cylinder device. In this way as well, the elasticity and/or rigidity of the respective brake system can be determined more accurately and more reliably.

Alternatively or in addition, according to an example embodiment of the present invention, the computing device can also be designed and/or programmed to estimate a dead volume of the brake system at least taking into account the estimated or read-out displaced brake fluid volume and the estimated or read-out change in pressure, and to determine the elasticity of the brake system and/or the rigidity of the brake system at least taking into account the estimated or read-out displaced brake fluid volume, the estimated or read-out change in pressure, and the estimated dead volume. The estimation and taking into account of the dead volume of the brake system can also contribute to improving the accuracy and reliability of the determined elasticity or rigidity of the respective brake system.

As an advantageous development of the present invention, the motor control device can in addition be designed and/or programmed to determine at least one target quantity relating to a target operating mode of the electric motor of the motorized piston-cylinder device, taking into account at least one specified quantity relating to a vehicle speed and/or vehicle deceleration requested by a driver or an automatic speed control system of the vehicle, and additionally taking into account the elasticity and/or rigidity of the brake system determined by the computing device, and, taking into account at least the determined target quantity, to output at least one motor control signal to the electric motor. The development described here of the device can bring about both a brake force boosting and also an autonomous braking of the respective vehicle, it being ensured in both cases, through the taking into account of the determined elasticity and/or rigidity of the respective brake system, that the requested vehicle speed and/or vehicle deceleration is reliably maintained.

The advantages described above may also be ensured in a vehicle brake system having such a device for parameter estimation and in the motorized piston-cylinder device having the electric motor controllable by the device.

The carrying out of a corresponding method for parameter estimation for a vehicle brake system equipped with a motorized piston-cylinder device also brings about the advantages described above. The method for parameter estimation can be developed according to the specific embodiments explained above of the device.

In addition, the carrying out of a corresponding method for operating a vehicle brake system equipped with a motorized piston-cylinder device also achieves the advantages described above; in this case as well, the method can be developed according to the specific embodiments of the device explained above.

### BRIEF DESCRIPTION OF THE DRAWINGS

Further features and advantages of the present invention are explained in the following on the basis of the Figures.

FIG. 1 shows a flow diagram for the explanation of a specific embodiment of the method for parameter estimation for a vehicle brake system equipped with a motorized piston-cylinder device, according to the present invention.

FIG. 2 shows a flow diagram for the explanation of a specific embodiment of the method for operating a vehicle brake system equipped with a motorized piston-cylinder device, according to the present invention.

FIGS. 3A and 3B show a schematic partial representation of a specific embodiment of the brake system and a coordinate system for the explanation of its pressure-volume characteristic curve, according to the present invention.

### DETAILED DESCRIPTION OF EXAMPLE EMBODIMENTS

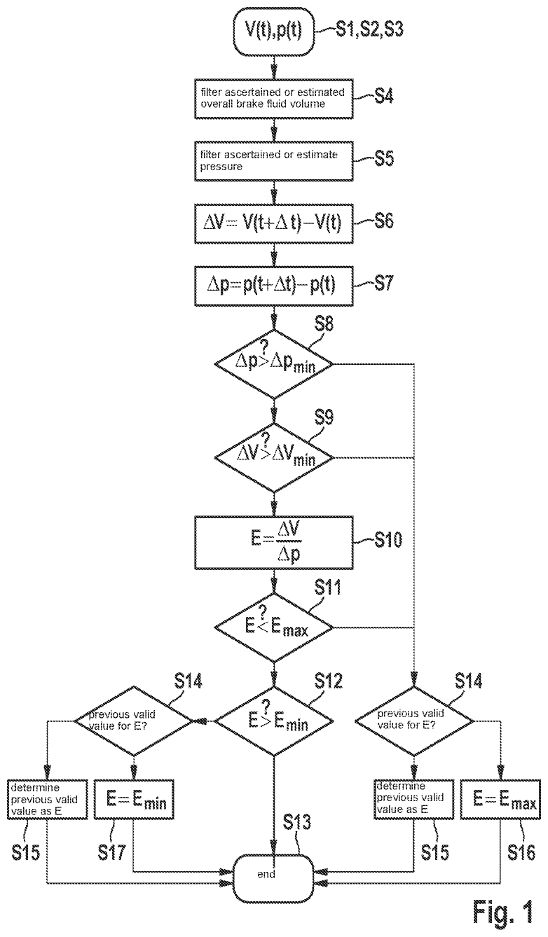

FIG. 1 shows a flow diagram for the explanation of a specific embodiment of the method for parameter estimation for a vehicle brake system equipped with a motorized piston-cylinder device.

The method described below can be carried out with (almost) any brake system that is at least equipped with a motorized piston-cylinder device, which can also be referred to as a motorized plunger device. The motorized piston-cylinder device is to be understood as a device having at least one piston situated inside a cylindrical volume, in which the at least one piston is capable of being displaced/is displaced linearly by operation of an electric motor of the motorized piston-cylinder device, in such a way that brake fluid is displaceable between the at least one cylindrical volume of the motorized piston-cylinder device and a connected brake system volume. The practicability of the method is likewise not limited to a specific type of vehicle or motor vehicle equipped with the respective brake system.

In a method step S1, the electric motor of the motorized piston-cylinder device is controlled in such a way that the at least one piston, displaceable by the operated electric motor, of the motorized piston-cylinder device is displaced from its respective initial position. In addition, when the method described here is carried out, a brake fluid volume ΔV displaced by the at least one displaceable piston of the motorized piston-cylinder device between the motorized piston-cylinder device and at least a part of the brake system adjoining the motorized piston-cylinder device is estimated or ascertained.

For example, a displacement path of the at least one piston, displaced by the controlled electric motor, of the motorized piston-cylinder device is estimated from its respective initial position or is read out from at least one displacement path sensor signal, and subsequently the brake fluid volume ΔV displaced by the at least one displaceable piston between the motorized piston-cylinder device and at least of the part of the brake system adjoining the motorized piston-cylinder device is estimated on the basis of the estimated displacement path of the at least one volume. The displacement path of the at least one displaceable piston can for example be estimated with a high degree of accuracy and good reliability on the basis of the controlling of the electric motor carried out as method step Sl, for example by correspondingly evaluating a current outputted to the electric motor in order to control it. Alternatively or in addition, the displacement path of the at least one displaceable piston can also be read out from a signal, evaluated as a displacement path sensor signal, of an angle of rotation sensor of the electric motor of the motorized piston-cylinder device. Optionally, at least one separate sensor can also be installed on the motorized piston-cylinder device to determine a current position of the at least one piston, whose signal is then evaluated as a displacement path sensor signal for reading out the displacement path of the at least one piston. If at least one volume sensor, designed to determine the brake fluid volume ΔV displaced by the at least one displaceable piston, is installed in the brake system, the displaced brake fluid volume ΔV can also be read out from at least one volume sensor signal of the at least one volume sensor.

Only as an example, in the method described here, as method step S2, in order to determine the brake fluid volume ΔV displaced by the at least one displaceable piston, an overall brake fluid volume V(t) of the brake system is continuously estimated or ascertained. The estimation or ascertaining of the overall brake fluid volume V(t) of the brake system can take place taking into account the respective displacement path of the at least one piston displaced by the controlled electric motor, the at least one displacement path sensor signal, and/or the at least one volume sensor signal.

In addition, when carrying out the method described here, a change in pressure Δp occurring at least in the part of the brake system adjoining the motorized piston-cylinder device due to the displaced brake fluid volume ΔV is ascertained or estimated. As the respective change in pressure Δp, for example a change in a system pressure can be estimated or measured by at least one system pressure sensor. As an example, in the specific embodiment described here a pressure p(t) prevailing in at least the part of the brake system adjoining the motorized piston-cylinder device is continuously ascertained or estimated as method step S3. Preferably, when carrying out method steps S2 and S3, care is taken that there are no large time delays between the ascertained or estimated values for the overall brake fluid volume V(t) and the pressure p(t).

In the specific embodiment of FIG. 1, in an (optional) method step S4 the ascertained or estimated overall brake fluid volume V(t) is subsequently filtered with a further variable low-pass filter. Likewise, in an optional method step S5 the ascertained or estimated pressure p(t) is filtered with a further variable low-pass filter. Using the low-pass filtering, carried out as method steps S4 and S5, a signal noise in the volume values V(t) and pressure values p(t), or the values derived later therefrom for the displaced brake fluid volume ΔV and the change in pressure Δp, can be limited.

In a method step S6, the displaced brake fluid volume ΔV is then determined according to equation (Eq. 1):

$$Δ V = V ( t + Δ t ) - V ( t ) \approx \frac{d V ( t )}{d t} \qquad ( Eq . 1 )$$

Correspondingly, in a method step S7 the change in pressure Δp is determined according to equation (Eq. 2):

$$Δ p = p ( t + Δ t ) - p ( t ) \approx \frac{d p ( t )}{d t} \qquad ( Eq . 2 )$$

In an optional method step S8, in the specific embodiment described here the change in pressure Δp determined in method step S7 is compared with a specified minimum change in pressure Δpₘᵢₙ. If the change in pressure Δp is greater than the minimum change in pressure Δpₘᵢₙ, the method can be continued with an optional method step S9. As method step S9, the displaced brake fluid volume ΔV determined in method step S6 can be compared with a specified minimum change in volume ΔVₘᵢₙ. If the determined displaced brake fluid volume ΔV is greater than the minimum change in volume ΔVₘᵢₙ, the method can be continued with method step S10.

In method step S10, an elasticity E of the brake system and/or a rigidity of the brake system is determined at least taking into account the displaced brake fluid volume ΔV and the change in pressure Δp. In the specific embodiment of FIG. 1 described here, in particular the elasticity of the brake system is determined according to equation (Eq. 3):

$$E = \frac{Δ V}{Δ p} \qquad ( Eq . 3 )$$

Equation (Eq. 3) can therefore be reliably used in particular because method step S8 ensures that the change in pressure Δp is sufficiently large. (In the case of a change in pressure Δp of almost 0, the elasticity E determined in this way would go towards infinity.) Moreover, method step S9 ensures that the elasticity E determined according to equation (Eq. 3) differs significantly from zero.

Alternatively or in addition, the rigidity of the brake system can also be determined according to equation (Eq. 4):

$$Σ = \frac{Δ p}{Δ V} \qquad ( Gl . 4 )$$

As an advantageous development, more complicated equations can also be used to determine the elasticity E of the brake system and/or the rigidity of the brake system in method step S10. For example, in at least one method step that is not shown, an intermediately stored storage volume V_{acc} temporarily stored in at least one storage chamber of the respective brake system can also be estimated or read out from at least one storage chamber sensor signal. The elasticity E of the brake system and/or the rigidity of the brake system may, if desired, then be determined at least taking into account the displaced brake fluid volume ΔV, the change in pressure Δp, and the storage volume V_{acc} temporarily stored in the at least one storage chamber. If the brake system also includes a further motorized brake pressure buildup device, then in addition a differential volume V_{diff} displaced by the motorized brake pressure buildup device into or out of at least the part of the brake system adjoining the motorized piston-cylinder device can also be estimated or determined, after which the elasticity E and/or the rigidity Σ of the respective brake system can be determined at least taking into account the displaced brake fluid volume ΔV, the change in pressure Δp, and the differential volume V_{diff} displaced into or out of at least the part of the brake system adjoining the motorized piston-cylinder device. In many brake systems, moreover, first a so-called dead volume V₀ has to be exceeded before a pressure buildup in the respective brake system begins through operation at least of the motorized piston-cylinder device. If this is true of the respective brake system, then the elasticity E of the brake system and/or the rigidity of the brake system can also be determined at least taking into account the displaced brake fluid volume ΔV, the change in pressure Δp, and the estimated dead volume V₀. In this way, to determine the elasticity E or the rigidity of the brake system, the equations (Eq. 5) and/or (Eq. 6) can also be used:

$$E = \frac{Δ V + {V}_{+}}{Δ p} \qquad ( Gl . 5 )$$

$$Σ = \frac{Δ p}{Δ V + {V}_{+}} \qquad ( Gl . 6 )$$

The quantity V₊ can optionally include the storage volume V_{acc} temporarily stored in the at least one storage chamber, the differential volume V_{diff} displaced by the motorized pressure buildup device, and/or the dead volume V₀.

As a possible development, in the determination of the elasticity E and/or of the rigidity Σ the respective brake system, a damping D and/or an inertia T of the respective brake system can also be taken into account. This can be done using equations (Eq. 7) and/or (Eq. 8):

$$p ( t ) = Σ * ( Δ V + {V}_{+} ) + D * \frac{dV ( t )}{d t} + T * \frac{{d}^{2} V ( t )}{d {t}^{2}} \qquad ( Eq . 7 )$$

$$E = \frac{1}{Σ} \qquad ( Eq . 8 )$$

However, here it is to be noted that the use of the six parameters elasticity E/rigidity Σ, storage volume V_{acc}, differential volume V_{diff}, dead volume V₀, damping D, and inertia T is merely optional. Instead of a complex and computationally intensive use of the equations (Eq. 7) or an equation derived therefrom for the elasticity E, in many cases it is enough to use only the equations (Eq. 3) and (Eq. 4) to determine the elasticity E and/or rigidity Σ. In order to ensure that the storage volume V_{acc}, differential volume V_{diff}, dead volume V₀, damping D, and inertia T of the respective brake system do not play a relevant role in the determination of the elasticity E and/or of the rigidity Σ of the respective brake system, corresponding test boundary conditions can moreover be maintained in the parameter determination. The maintaining of these test boundary conditions can be ensured for example by the signal filtering carried out by method steps S4 and S5.

In addition, using the method steps described below, it can be ensured that the value E determined by equation (Eq. 3) is a reliable value for the elasticity E. For this purpose, in an optional method step S11 the value E determined by equation (Eq. 3) is first compared with a maximum value Eₘₐₓ specified for the elasticity. If the value E determined by equation (Eq. 3) is smaller than the maximum value Eₘₐₓ, then the method is continued with an optional method step S12, in which the value E determined by equation (Eq. 3) is compared with a minimum value Eₘᵢₙ specified for the elasticity. Only if the value E determined by equation (Eq. 3) is greater than the minimum value Eₘᵢₙ is the value E determined as the elasticity E, in a method step S13.

If the change in pressure Op determined in method step S7 is less than or equal to the minimum change in pressure Δpₘᵢₙ, the displaced brake fluid volume ΔV determined in method step S6 is less than or equal to the minimum change in volume ΔVₘᵢₙ, or the value E determined by equation (Eq. 3) is greater than or equal to the maximum value Eₘₐₓ, then, in the specific embodiment of the method described here, an optional method step S14 is carried out. In method step S14, it is queried whether there is a previous valid value for the elasticity E. If this is the case, then, as method step S15, the previous valid value is determined as value E, and the method ends with method step S13. Otherwise, in a method step S16 the maximum value Eₘₐₓ is determined as the value E, and the method ends with method step S13.

Method step S14 is also carried out when the value E determined by equation (Eq. 3) is less than or equal to the minimum value Eₘᵢₙ. If there is a previous valid value for the elasticity E, then method steps S13 and S15 are carried out. Otherwise, as method step S17 the minimum value Eₘᵢₙ is determined as the value E, and the method ends with method step S13.

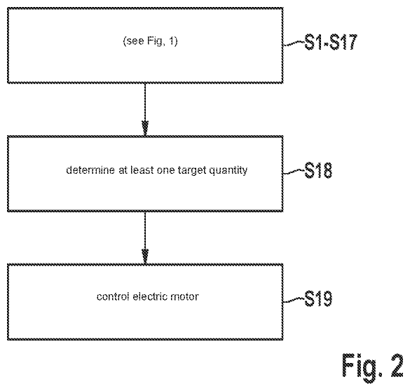

FIG. 2 shows a flow diagram explaining a specific embodiment of the method for operating a vehicle brake system equipped with a motorized piston-cylinder device.

The method described here can also be realized with (almost) any brake system that is equipped with at least one motorized piston-cylinder device. The practicability of the method is likewise not limited to any specific type of vehicle or motor vehicle equipped with the respective brake system.

In the method described here, first an elasticity E of the brake system and/or a rigidity Σ of the brake system are determined. This can be done for example by carrying out at least one of the method steps S1 through S17 explained above.

Later, as method step S18, at least one target quantity is determined relating to a target operating mode of the electric motor of the motorized piston-cylinder device, taking into account at least one specified quantity relating to a vehicle speed and/or vehicle acceleration requested by a driver or automated speed control system of the vehicle, and additionally taking into account the determined elasticity E and/or rigidity Σ of the brake system. The automated speed control system can be understood for example as an adaptive cruise control system, an automated system for autonomous driving of the vehicle, and/or an emergency braking system. In particular, first, a brake pressure p_{target} that is to be brought about in at least one wheel brake cylinder of the brake system can be determined. Subsequently, as the at least one target quantity a volume flow q that is to be brought about by the motorized piston-cylinder device can be determined, by which the desired brake pressure p_{target} can be built up in at the at least one wheel brake cylinder, determined according to equation (Eq. 9):

$$q = E * \frac{{dp}_{t a r g e t}}{d t} \qquad ( Eq . 9 )$$

In a further method step S19, the electric motor of the motorized piston-cylinder device is controlled by outputting at least one motor control signal to the electric motor, taking into account at least the determined target quantity. For example, for this purpose, as the at least one motor control signal a current signal can be outputted to the electric motor, which signal brings it about that the electric motor supplied with current initiates the desired volume flow q by displacing the at least one piston of the motorized piston-cylinder device.

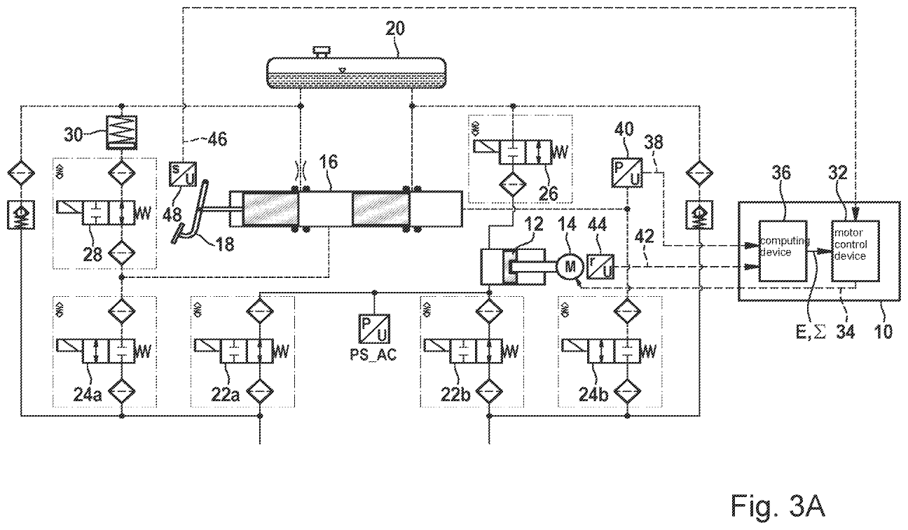

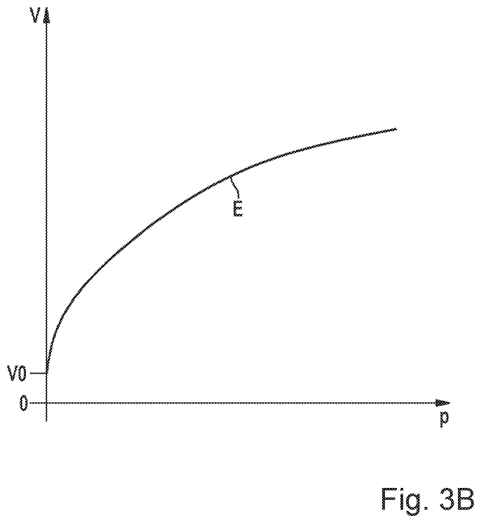

FIGS. 3A and 3b show a schematic partial representation of a specific embodiment of the brake system and a coordinate system for explaining its pressure-volume characteristic curve.

The brake system partially shown schematically in FIG. 3A has at least one device 10 for parameter estimation and a motorized piston-cylinder device 12 having an electric motor 14 controllable by device 10. At least one piston of motorized piston-cylinder device 12 can be linearly displaced by operation of its electric motor 14 in such a way that brake fluid can be displaced between motorized piston-cylinder device 12 and a remaining volume of the brake system.

Shown merely as examples in FIG. 3A, as additional components of the brake system, are a master brake cylinder 16 having an upstream brake pedal 18, a brake fluid reservoir 20, a first separating valve 22a for connecting or decoupling a first chamber of master brake cylinder 16 to a first brake circuit (not shown) of the brake system, a second separating valve 22b for connecting or decoupling a second chamber of the master brake cylinder 16 to a second brake circuit (not shown) of the brake system, a third separating valve 24a for connecting or decoupling the motorized piston-cylinder device 12 to the first brake circuit, a fourth separating valve 24b for connecting or decoupling the motorized piston-cylinder device 12 to the second brake circuit, a fifth separating valve 26 for connecting the motorized piston-cylinder device 12 to brake fluid reservoir 20, and a simulator separating valve 28 for connecting or decoupling a simulator 30 to the first chamber of master brake cylinder 16. Each of the two brake circuits of the brake system has at least one wheel brake cylinder. For example, each of the two brake circuits can have two wheel brake cylinders each. Optionally, at least one of the two brake circuits can further be fashioned having at least one wheel inlet valve, at least one wheel outlet valve, a storage chamber situated downstream from its at least one wheel outlet valve, and/or a return pump. However, the individual components of the two brake circuits are not graphically shown in FIG. 3A. Moreover, it is expressly noted here that the components of the brake system described in the present paragraph are to be interpreted only as examples. The applicability of device 10 described below is not limited to such a brake system or to a specific type of vehicle or motor vehicle equipped with the respective brake system.

Device 10 has a motor control device 32 that is designed and/or programmed to control electric motor 14 of motorized piston-cylinder device 12 using at least one motor control signal 34, in such a way that the at least one displaceable piston of motorized piston-cylinder device 12 can be displaced or is displaced from its respective initial position by the controlled electric motor 14. In addition, device 10 includes a computing device 36 that is designed and/or programmed to estimate a brake fluid volume displaced by the at least one displaceable piston between motorized piston-cylinder device 12 and at least a part of the brake system adjoining motorized piston-cylinder device 12, or to read it out from at least one volume sensor signal provided to computing device 36, and to estimate a change in pressure occurring due to the displaced brake fluid volume at least in the part of the brake system adjoining motorized piston-cylinder device 12, or to read it out from at least one pressure sensor signal 38 provided to computing device 36. The at least one pressure sensor signal 38 can be outputted to computing device 36 for example by a system pressure sensor 40. In the specific embodiment described here, computing device 36 is moreover designed and/or programmed to read out a displacement path of the at least one piston, displaced by the controlled electric motor 14, of motorized piston-cylinder device 12 from its respective initial position from a displacement path sensor signal 42 provided to computing device 36, and subsequently to estimate the brake fluid volume displaced by the at least one displaceable piston between motorized piston-cylinder device 12 and at least the part of the brake system adjoining motorized piston-cylinder device 12, on the basis of the estimated or read-out displacement path of the at least one displaced piston. The at least one displacement path sensor signal 42 can be outputted to computing device 36 in particular by an angle of rotation sensor 44 of electric motor 14.

In addition, computing device 36 is designed and/or programmed to determine an elasticity E of the brake system and/or a rigidity Σ of the brake system at least taking into account the estimated or read-out displaced brake fluid volume and the estimated or read-out change in pressure. This can take place in particular using at least one of the equations indicated above. Even if the brake system has an “unusual” elasticity E or rigidity Σ due to its large-scale production, aging, or change due to environmental conditions, the respective values can be reliably determined by device 10. In the coordinate system of FIG. 3B, an example is shown of a characteristic curve k that can be determined by computing device 36 for the elasticity E of the brake system, where an abscissa of the coordinate system indicates a pressure p in the brake system and an ordinate of the coordinate system indicates an overall brake fluid volume V of the brake system. In addition, a dead volume V₀ of the brake system is shown in the coordinate system of FIG. 3B.

In a development not shown graphically, device 10 can also have a first low-pass filter device and/or a second low-pass filter device, and computing device 36 can be designed and/or programmed to determine the elasticity E of the brake system and/or the rigidity Σ of the brake system at least taking into account the displaced brake fluid volume, unfiltered or filtered by the first low-pass filter device, and the change in pressure, unfiltered or filtered by the second low-pass filter device. Likewise, computing device 36 can also be designed and/or programmed to estimate a storage volume temporarily stored in at least one storage chamber (not shown) of the brake system, or to read it out from at least one storage chamber sensor signal provided to the computing device, and/or to estimate a dead volume V₀ of the brake system. In this case, the computing device 36 is preferably also designed and/or programmed to determine the elasticity E of the brake system and/or the rigidity Σ of the brake system, also taking into account the storage volume temporarily stored in the at least one storage chamber and/or the estimated dead volume V₀. If motor control device 32 controls an electric motor of a motorized rate pressure buildup device (not shown) of the brake system in such a way that a differential volume can be displaced by the motorized brake pressure buildup device into or out of at least the part of the brake system adjoining the motorized piston-cylinder device, then computing device 36 can in addition be designed and/or programmed to estimate the differential volume or to read it out from at least one further volume sensor signal provided to the computing device, and to determine the elasticity E and/or the rigidity Σ of the brake system additionally taking into account the differential volume displaced into or out of at least the part of the brake system adjoining the motorized piston-cylinder device. As an advantageous development, motor control device 32, in the specific embodiment of device 10 described here, is also designed and/or programmed to determine at least one target quantity relating to a target operating mode of electric motor 14 of the motorized piston-cylinder device, taking into account at least one specified quantity 46 relating to a vehicle speed and/or vehicle deceleration requested by a driver or by an automated speed control system of the vehicle, and additionally taking into account the elasticity E and/or rigidity Σ of the brake system determined by computing device 36. The at least one specified quantity 46 can for example also be provided to motor control device 32 by a rod path sensor 48 and/or a differential path sensor. Motor control device 32 then outputs the at least one motor control signal 34 to electric motor 14 taking into account at least the determined target quantity. Device 10 can thus also be used for active or autonomous pressure modulations.

1-10. (canceled)

11. A device for parameter estimation for a vehicle brake system equipped with a motorized piston-cylinder device, the device comprising:
a motor control device configured to control an electric motor of the motorized piston-cylinder device in such a way that at least one displaceable piston of the motorized piston-cylinder device is displaceable by the controlled electric motor from its respective initial position; and
a computing device configured to: (i) estimate a brake fluid volume displaced by the at least one displaceable piston between the motorized piston-cylinder device and at least a part of the brake system adjoining the motorized piston-cylinder device, or read out the displaced brake fluid volume from at least one volume sensor signal provided to the computing device, and/or (ii) estimate a change in pressure occurring due to the displaced brake fluid volume at least in the part of the brake system adjoining the motorized piston-cylinder device, or to read out the change in pressure from at least one pressure sensor signal provided to the computing device;
wherein the computing device is configured to estimate an elasticity of the brake system and/or a rigidity of the brake system at least taking into account the estimated or read-out displaced brake fluid volume and the estimated or read-out change in pressure.

12. The device as recited in claim 11, wherein the device includes a first low-pass filter device and/or a second low-pass filter device, and the computing device is configured to determine the elasticity of the brake system and/or the rigidity of the brake system at least taking into account the estimated or read-out displaced brake fluid volume, unfiltered or filtered by the first low-pass filter device, and the estimated or read-out change in pressure, unfiltered or filtered by the second low-pass filter device.

13. The device as recited in claim 11, wherein the computing device is configured to estimate a displacement path of the at least one piston, displaced by the controlled electric motor, of the motorized piston-cylinder device from its respective initial position, or to read out the displacement path from at least one displacement path sensor signal provided to the computing device, and the computing device is configured to estimate the brake fluid volume displaced by the at least one displaceable piston between the motorized piston-cylinder device and at least the part of the brake system adjoining the motorized piston-cylinder device based on the estimated or read-out displacement path of the at least one displaced piston.

14. The device as recited in claim 11, wherein the computing device is configured to estimate a storage volume temporarily stored in at least one storage chamber of the brake system, or to read out the storage volume from at least one storage chamber sensor signal provided to the computing device, and the computing device is configured to determine the elasticity of the brake system and/or the rigidity of the brake system at least taking into account the estimated or read-out displaced brake fluid volume, the estimated or read-out change in pressure, and the storage volume temporarily stored in the at least one storage chamber.

15. The device as recited in claim 11, wherein the motor control device is configured to control an electric motor of a motorized brake pressure buildup device of the brake system in such a way that a differential volume is displaceable, by the motorized brake pressure buildup device, into or out of at least the part of the brake system adjoining the motorized piston-cylinder device, and the computing device is configured to estimate the differential volume or to read out the differential volume from at least one further volume sensor signal provided to the computing device, and to determine the elasticity of the brake system and/or the rigidity of the brake system at least taking into account the estimated or read-out displaced brake fluid volume, the estimated or read-out change in pressure, and the differential volume displaced into or out of at least the part of the brake system adjoining the motorized piston-cylinder device.

16. The device as recited in claim 11, wherein the computing device is configured to estimate a dead volume of the brake system at least taking into account the estimated or read-out displaced brake fluid volume and the estimated or read-out change in pressure, and to determine the elasticity of the brake system and/or the rigidity of the brake system at least taking into account the estimated or read-out displaced brake fluid volume, the estimated or read-out change in pressure, and the estimated dead volume.

17. The device as recited in claim 11, wherein the motor control device is configured to determine at least one target quantity relating to a target operating mode of the electric motor of the motorized piston-cylinder device taking into account at least one specified quantity relating to a vehicle speed and/or vehicle deceleration requested by a driver or automatic speed control system of the vehicle, and taking into account the elasticity and/or rigidity of the brake system determined by the computing device, and to output at least one motor control signal to the electric motor taking into account at least the determined target quantity.

18. A brake system for a vehicle, comprising:
a device for parameter estimation for the brake system, the brake system equipped with a motorized piston-cylinder device, the device including:
a motor control device configured to control an electric motor of the motorized piston-cylinder device in such a way that at least one displaceable piston of the motorized piston-cylinder device is displaceable by the controlled electric motor from its respective initial position; and
a computing device configured to: (i) estimate a brake fluid volume displaced by the at least one displaceable piston between the motorized piston-cylinder device and at least a part of the brake system adjoining the motorized piston-cylinder device, or read out the displaced brake fluid volume from at least one volume sensor signal provided to the computing device, and/or (ii) estimate a change in pressure occurring due to the displaced brake fluid volume at least in the part of the brake system adjoining the motorized piston-cylinder device, or to read out the change in pressure from at least one pressure sensor signal provided to the computing device;
wherein the computing device is configured to estimate an elasticity of the brake system and/or a rigidity of the brake system at least taking into account the estimated or read-out displaced brake fluid volume and the estimated or read-out change in pressure; and
the motorized piston-cylinder device having the electric motor, the electric motor being controllable by the device.

19. A method for parameter estimation for a vehicle brake system equipped with a motorized piston-cylinder device, comprising the following steps:
controlling an electric motor of the motorized piston-cylinder device in such a way that at least one piston, displaceable by the operated electric motor, of the motorized piston-cylinder device is displaced from its respective initial position;
(i) ascertaining or estimating a brake fluid volume displaced by the at least one displaceable piston of the motorized piston-cylinder device between the motorized piston-cylinder device and at least a part of the brake system adjoining the motorized piston-cylinder device, and/or (ii) ascertaining or estimating a change in pressure occurring due to the displaced brake fluid volume at least in the part of the brake system adjoining the motorized piston-cylinder device; and
determining an elasticity of the brake system and/or a rigidity of the brake system at least taking into account the ascertained or estimated displaced brake fluid volume and the ascertained or estimated change in pressure.

20. A method for operating a vehicle brake system equipped with a motorized piston-cylinder device, comprising the following steps:
determining an elasticity of the brake system and/or a rigidity of the brake system by:
controlling an electric motor of the motorized piston-cylinder device in such a way that at least one piston, displaceable by the operated electric motor, of the motorized piston-cylinder device is displaced from its respective initial position,
(i) ascertaining or estimating a brake fluid volume displaced by the at least one displaceable piston of the motorized piston-cylinder device between the motorized piston-cylinder device and at least a part of the brake system adjoining the motorized piston-cylinder device, and/or (ii) ascertaining or estimating a change in pressure occurring due to the displaced brake fluid volume at least in the part of the brake system adjoining the motorized piston-cylinder device, and
determining the elasticity of the brake system and/or the rigidity of the brake system at least taking into account the ascertained or estimated displaced brake fluid volume and the ascertained or estimated change in pressure;
determining at least one target quantity relating to a target operating mode of the electric motor of the motorized piston-cylinder device, taking into account at least one specified quantity relating to a vehicle speed and/or vehicle deceleration requested by a driver or automatic speed control system of the vehicle, and taking into account the determined elasticity and/or rigidity of the brake system; and
controlling the electric motor of the motorized piston-cylinder device by outputting at least one motor control signal to the electric motor taking into account at least the determined target quantity.
